(19) United States
(12) Patent Application Publication
(10) Pub. No.: US 2024/0040455 A1
(43) Pub. Date: Feb. 1, 2024

(54) METHOD AND APPARATUS FOR CONFIRMING F1 TERMINATION DONOR NODE

(71) Applicant: SAMSUNG ELECTRONICS CO., LTD., Suwon-si (KR)

(72) Inventors: Fanhua KONG, Beijing (CN); Weiwei WANG, Beijing (CN); Lixiang XU, Beijing (CN); Hong WANG, Beijing (CN)

(21) Appl. No.: 18/363,617

(22) Filed: Aug. 1, 2023

(30) Foreign Application Priority Data
Aug. 1, 2022 (CN) 202210917115.1

(51) Int. Cl. H04W 36/08

(52) U.S. Cl. CPC H04W 36/08

(57) ABSTRACT

The disclosure relates to a 5G or 6G communication system for supporting a higher data transmission rate. A method performed by a first target donor node in a wireless communication system, the method comprising: transmitting, to a source donor node, a first handover request message, receiving, from the source donor node, a first handover response message corresponding to the first handover request message, and performing, a partial migration with a migrating node in case that the first handover response message indicates acknowledge (ACK).

### CROSS-REFERENCE TO RELATED APPLICATION

This application is based on and claims priority under 35 U.S.C. § 119 to Chinese Patent Application No. 202210917115.1 filed on Aug. 1, 2022, in the China National Intellectual Property Office, the disclosure of which is incorporated by reference herein in its entirety.

### BACKGROUND

### 1. Field

The application relates to the technical field of wireless communication. More particularly, the disclosure relates to a donor node and a method performed by the donor node.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

This disclosure relates to wireless communication networks, and more particularly to a terminal and a communication method thereof in a wireless communication system.

In accordance with an aspect of the disclosure, a method performed by a first target donor node in a wireless communication system is provided, which includes: determining to migrate a radio resource control (RRC) connection of a migrating node established on the first target donor node to a second target donor node, transmitting a second handover request message to the second target donor node, wherein the second handover request message carries first assistance information, and the first assistance information comprises configuration information used for realizing RRC connection migration, and receiving a second handover request acknowledge message transmitted by the second target donor node.

Aspects of the disclosure are to address at least the above-mentioned problems and/or disadvantages and to provide at least the advantages described below. Accordingly, an aspect of the disclosure is to provide efficient communication methods in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates SAE according to an embodiment of the present disclosure;

FIG. 2 illustrates an initial overall architecture of 5G according to an embodiment of the present disclosure;

FIG. 3a illustrates a first example of a base station structure according to an embodiment of the present disclosure;

FIG. 3b illustrates a second example of the base station structure according to an embodiment of the present disclosure;

FIG. 3c illustrates a third example of the base station structure according to an embodiment of the present disclosure;

FIG. 4 illustrates an example for performing multiple partial migration first and then full migration according to an embodiment of the present disclosure;

FIG. 5 illustrates an example for of performing partial migration among multiple target IAB donor CUs according to an embodiment of the present disclosure;

FIG. 6 illustrates an example for performing F1 migration among multiple target IAB donor CUs according to an embodiment of the present disclosure;

FIG. 7 illustrates a flowchart of a method performed by a first target donor node in a wireless communication system according to an embodiment of the present disclosure;

FIG. 8 illustrates a flowchart of a method performed by a source donor node in a wireless communication system according to an embodiment of the present disclosure;

FIG. 9 illustrates a flowchart of a method performed by a first target donor node in a wireless communication system according to another embodiment of the present disclosure;

FIG. 10 illustrates a flowchart of a method performed by a source donor node in a wireless communication system according to an embodiment of the present disclosure;

FIG. 11 illustrates a flowchart of a method by a target IAB donor CU which an RRC connection is established on for determining a next target IAB donor CU according to an embodiment of the present disclosure;

FIG. 12 illustrates a first flowchart of assisting, by a source IAB donor CU, a target IAB donor CU in determining a next Target donor CU according to an embodiment of the present disclosure;

FIG. 13 illustrates a second flowchart of assisting, by a source IAB donor CU, a target IAB donor CU in determining a next Target donor CU according to an embodiment of the present disclosure;

FIG. 14 illustrates a flowchart of determining, by a source IAB donor CU, a next Target donor CU according to an embodiment of the present disclosure;

FIG. 15 illustrates a flowchart of assisting, by a target IAB donor CU, a source IAB donor CU in determining an F1 termination donor CU according to an embodiment of the present disclosure;

FIG. 16 illustrates a flowchart of migrating F1 to a target IAB donor CU which an RRC connection is established on according to an embodiment of the present disclosure;

FIG. 17 illustrates an example of migrating F1 to a target IAB donor CU which RRC connection is not established on according to an embodiment of the present disclosure;

FIG. 18 illustrates an example of migrating both F1 and RRC to a target IAB donor CU which RRC connection is not established on according to an embodiment of the present disclosure;

FIG. 19 illustrates a donor node according to an embodiment of the present disclosure;

FIG. 20 illustrates various hardware components of a UE according to the embodiments as disclosed herein; and

FIG. 21 illustrates various hardware components of a base station according to the embodiments as disclosed herein.

Throughout the drawings, it should be noted that like reference numbers are used to depict the same or similar elements, features, and structures.

### DETAILED DESCRIPTION

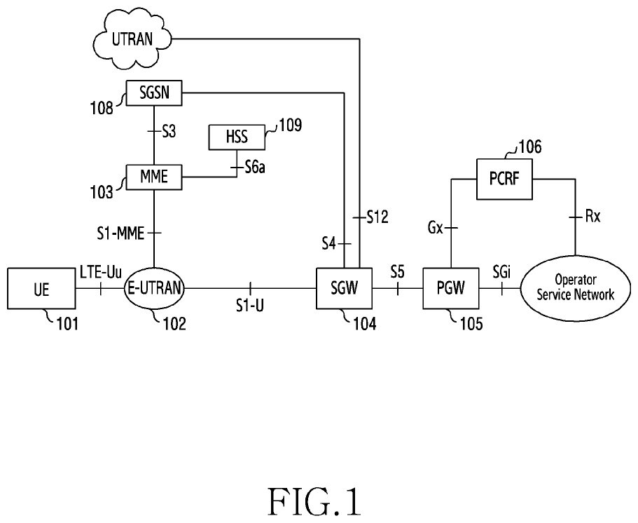

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects of the disclosure are to address at least the above-mentioned problems and/or disadvantages and to provide at least the advantages described below. Accordingly, an aspect of the disclosure is to provide a terminal and a communication method thereof in a wireless communication system.

The application provides a donor node and a method performed by the donor node, which can improve coverage and enhance partial migration. The following technical solutions are employed.

In a first aspect, a method performed by a first target donor node in a wireless communication system is provided, which includes:
determining to migrate a radio resource control (RRC) connection of a migrating node established on the first target donor node to a second target donor node;
transmitting a second handover request message to the second target donor node, wherein the second handover request message carries first assistance information, and the first assistance information comprises configuration information used for realizing RRC connection migration; and
receiving a second handover request acknowledge message transmitted by the second target donor node.

In a second aspect, a method performed by a source donor node in a wireless communication system is provided, which includes:
receiving indication information, transmitted by a first target donor node, for indicating, to the source donor node, migrating an RRC connection of a migrating node to a second target donor node which is decided by the first target node, the RRC connection of the migrating node being established on the first target donor node.

In a third aspect, a method performed by a first target donor node in a wireless communication system is provided, which includes:
receiving a first measurement report transmitted by a migrating node which is migrated to the first target donor; and
transmitting the received first measurement report to a source donor node, the first measurement report being used by the source donor node to determine a donor node which a RRC connection of the migrating node is to be migrated to.

In a fourth aspect, a method performed by a source donor node in a wireless communication system is provided, which includes:
receiving a first measurement report transmitted by a first target donor node, the first measurement report being transmitted by a migrating node to the first target donor node, and a radio resource control (RRC) connection of the migrating node being established on the first target donor node; and
determining, based on the first measurement report, a second target donor node which the RRC connection of the migrating node is to be migrated to.

In a fifth aspect, a method performed by a first target donor node in a wireless communication system is provided, which includes:
receiving fifth indication information transmitted by the source donor node, the fifth indication information being configured for indicating, to the first target donor node which an RRC connection of a migrating node is established on, to provide second assistance information used for realizing F1 migration; and
transmitting a second measurement report to the source donor node, the second measurement report carrying the second assistance information used for realizing F1 migration.

In a sixth aspect, a method performed by a source donor node in a wireless communication system is provided, which includes:
transmitting fifth indication information to a first target donor node which an RRC connection is established on, the fifth indication information being configured for indicating, to the fourth target donor node, to provide the second assistance information used for realizing F1 migration;
receiving a measurement report transmitted by the first target donor node, the measurement report carrying the second assistance information used for realizing F1 migration; and
when full migration is to be performed, determining, according to the second assistance information, a donor node which F1 is to be migrated to.

In a seventh aspect, a method performed by a fourth target donor node in a wireless communication system is provided, which includes:
receiving a fourth handover request message transmitted by a source donor node, the fourth handover request message being configured for requesting to migrate F1 to the fourth target donor node, the fourth target donor node being a donor node different from a first target donor node which an RRC connection is established on; and
transmitting, to the source donor node, a fourth handover request acknowledge message carrying the information on handover request acknowledge.

In an eighth aspect, a method performed by a fourth target donor node in a wireless communication system is provided, which includes:
receiving a second request message transmitted by a source donor node, the second request message carrying related information required in a migration process of a migrating node; and
transmitting a second response message to the source donor node, the second response message carrying configuration information used for realizing full migration that is configured by the fourth target donor node, and the fourth target donor node being a donor node different from a first target donor node which an RRC connection is established on.

In a ninth aspect, a first target donor node in a wireless communication system is provided, which includes:
a transceiver; and
a controller coupled to the transceiver, the controller being configured to execute the operations corresponding to the methods described in the first aspect or the third aspect or the fifth aspect of the application.

In an eleventh aspect, a source donor node in a wireless communication system is provided, which includes:
a transceiver; and
a controller coupled to the transceiver, the controller being configured to execute the operations corresponding to the methods described in the second aspect or the fourth aspect or the sixth aspect of the application.

In a tenth aspect, a source donor node in a wireless communication system is provided, which includes:
a transceiver; and
a controller coupled to the transceiver, the controller being configured to execute the operations corresponding to the methods described in the seventh aspect or the eighth aspect of the application.

In a twelfth aspect, a computer-readable storage medium is provided, the computer-readable storage medium having computer programs stored thereon that, when executed by a processor, implement the methods described in the first aspect or the second aspect, or the third aspect or the fourth aspect, or the fifth aspect or the sixth aspect, or the seventh aspect or the eighth aspect of the application.

The technical solutions provided by the application have the following beneficial effects.

A first target donor node determines to migrate an RRC connection of a migrating node established on the first target donor node to a second target donor node and then transmits a handover request message to the second target donor node, and the handover request message carries first assistance information including configuration information used for realizing RRC connection migration, so that the partial migration can be enhanced to provide coverage.

The following description with reference to the accompanying drawings is provided to assist in a comprehensive understanding of various embodiments of the application as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the application. In addition, descriptions of well-known functions and constructions may be omitted for clarity and conciseness.

The terms and words used in the following description and claims are not limited to the bibliographical meanings, but are merely used by the inventor to enable a clear and consistent understanding of the application. Accordingly, it should be apparent to those skilled in the art that the following description of various embodiments of the application is provided for illustration purpose only and not for the purpose of limiting the application as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the application and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the application includes any or all of combinations of listed words. For example, the expression “A or B” may include A, may include B, or may include both A and B.

Unless defined differently, all terms used in the application, which include technical terminologies or scientific terminologies, have the same meaning as that understood by a person skilled in the art to which the application belongs. Such terms as those defined in a generally used dictionary are to be interpreted to have the meanings equal to the contextual meanings in the relevant field of art, and are not to be interpreted to have ideal or excessively formal meanings unless clearly defined in the application.

To make the objectives, technical solutions and advantages of the application clearer, the application will be further described below in details by embodiments with reference to the drawings.

The text and the drawings are merely provided as examples to help readers to understand the application. They should not be construed as limiting the scope of the application in any way. Although certain embodiments and examples have been provided, based on the contents disclosed herein, it is obvious to those skilled in the art that the illustrated embodiments and examples can be modified without departing from the scope of the application.

The above and other features, aspects and advantages of the embodiments of the application will be better understood with reference to the following description and the appended claims. The drawings of the specification constituting part of the application illustrate the exemplary embodiments of the application and are used with the specification to explain the related principles. The details of one or more implementations of the subject matter of the application are set forth in the drawings of the description and the following description. Other potential features, aspects and advantages of the subject matter of the disclosure will become apparent from these descriptions, drawings and claims.

FIGS. 1 to 21 discussed below and various embodiments for describing the principles of the present disclosure in this patent document are only for illustration and should not be interpreted as limiting the scope of the application in any way. Those skilled in the art will understand that the principles of the application can be implemented in any suitably arranged system or device.

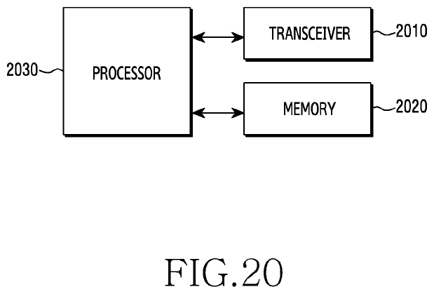

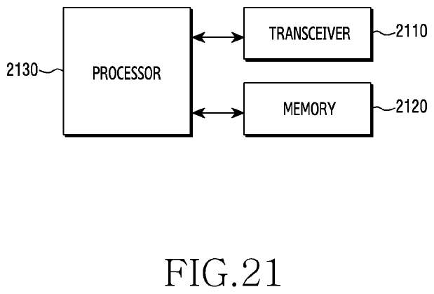

FIG. 1 is an exemplary system architecture 100 of system architecture evolution (SAE). user equipment (UE) 101 is a terminal device for receiving data. And the UE 101 corresponds to the UE of the FIG. 20. An evolved universal terrestrial radio access network (E-UTRAN) 102 is a radio access network, which includes a macro base station (eNodeB/NodeB) that provides UE with interfaces to access the radio network. And the E-UTRAN 102 corresponds to the base station of the FIG. 21. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

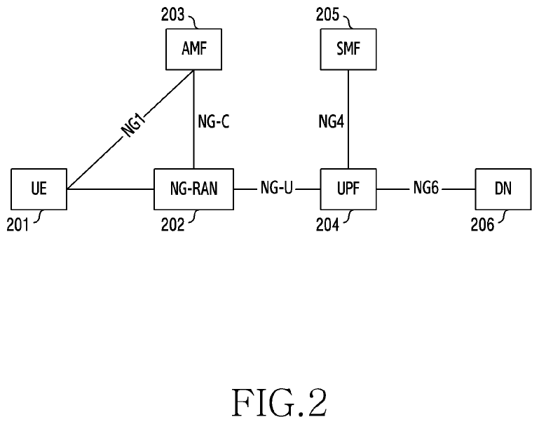

FIG. 2 illustrates an initial overall architecture of 5G according to an embodiment of the present disclosure.

FIG. 2 is an exemplary system architecture 200 according to various embodiments of the application. Other embodiments of the system architecture 200 can be used without departing from the scope of the application.

User equipment (UE) 201 is a terminal device for receiving data. And the UE 201 corresponds to the UE of the FIG. 20. A next generation radio access network (NG-RAN, or RAN for short) 202 is a radio access network, which includes a base station (a gNB or an eNB connected to a 5G core network (5GC)) that provides the UE with an interface to access a radio network. And the NG-RAN 202 corresponds to the base station of the FIG. 21. An access control and mobility management function entity (AMF) 203 is responsible for managing mobility context and security information of the UE. A user plane function entity (UPF) 204 mainly provides a function of user plane. A session management function entity (SMF) 205 is responsible for session management. A data network (DN) 206 includes operators' services, access to Internet, third-party services, etc. An interface between the AMF and the NG-RAN is called an NG-C interface, an NG interface or an N2 interface. AN interface between the UPF and the NG-RAN is called an NG-U interface or an N3 interface, and a signaling between the UE and the AMF is called non-access stratum (NAS) signaling or also called an N1 interface. An interface between base stations is called an Xn interface.

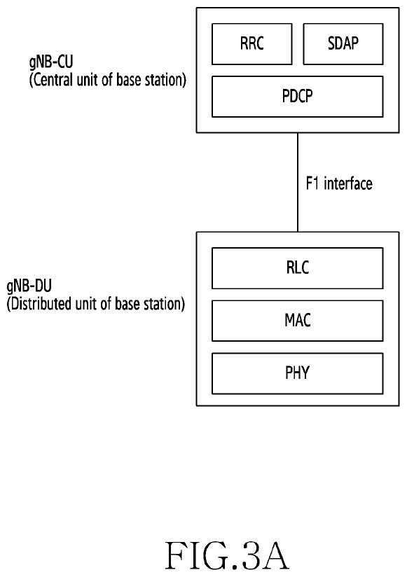

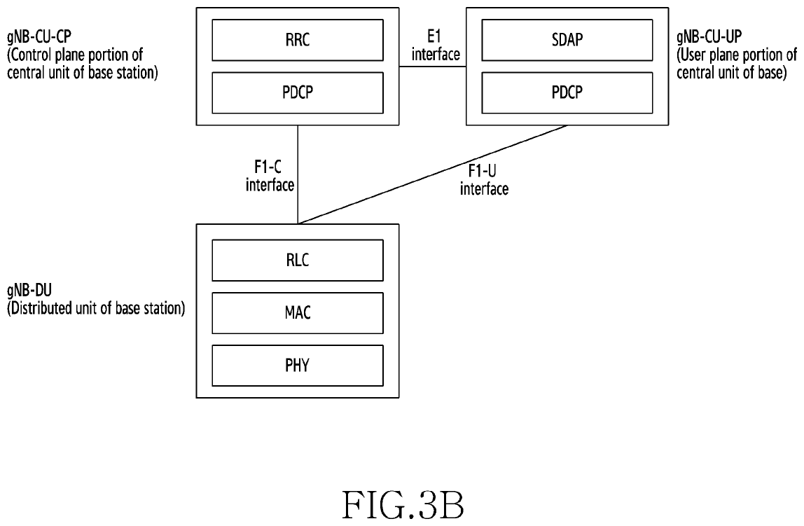

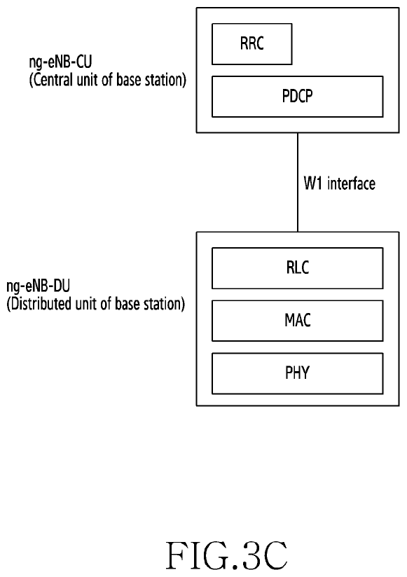

In an NR system, in order to support network function virtualization and more efficient resource management and scheduling, the base station (gNB/ng-eNB) that provides the terminal (UE) with a radio network interface may be further divided into a gNB central unit/ng-eNB central unit (gNB-CU/ng-eNB-CU, referred to as CU for short herein) and a gNB distributed unit/ng-eNB distributed unit (gNB-DU/ng-eNB-DU, referred to as DU for short herein), as shown in FIG. 3a. FIG. 3a is a first example diagram of a base station structure.

The gNB-CU has a radio resource control (RRC) layer, a service data adaptation protocol (SDAP) layer, a packet data convergence protocol (PDCP) layer, etc., and the ng-eNB-CU has an RRC layer and a PDCP layer. The gNB-DU/ng-eNB-DU has a radio link control (RLC) protocol layer, a medium access control (MAC) layer, a physical layer, etc. There is a standardized open interface F1 between the gNB-CU and the gNB-DU, and there is a standardized open interface W1 between the ng-eNB-CU and the ng-eNB-DU. The F1 interface is categorized into a control plane F1-C and a user plane F1-U. A transport network layer of the F1-C is based on IP transport. To realize more reliable transmission of signaling, an SCTP protocol is added on top of the IP. The protocol of the application layer is F1AP. The SCTP can provide reliable transmission of application layer messages. The transport layer of the F1-U is UDP/IP, and the GTP-U is on top of the UDP/IP and configured for carrying a user plane protocol data unit (PDU).

FIG. 3b illustrates a second example of the base station structure according to an embodiment of the present disclosure.

For the gNB-CU, as shown in FIG. 3b, the gNB-CU may include a gNB-CU-CP (a control plane portion of the central unit of the base station) and a gNB-CU-UP (a user plane portion of the central unit of the base station). The gNB-CU-CP contains the function of the control plane of the base station, and has an RRC layer and a PDCP layer. The gNB-CU-UP contains the function of the user plane of the base station, and has an SDAP layer and a PDCP layer. There is a standardized open interface E1 between the gNB-CU-CP and the gNB-CU-UP, and the protocol used therebetween is E1AP. An interface between the control plane portion of the central unit of the base station and the distributed unit of the base station is an F1-C interface, i.e., a control plane interface of F1. An interface between the user plane portion of the central unit of the base station and the distributed unit of the base station is an F1-U interface, i.e., a user plane interface of F1.

In addition, in the NR system, a base station that accesses a 5G core network and provides the E-UTRA user plane and control plane is called the ng-eNB. In order to support virtualization, this base station (ng-eNB) may be further divided into a gNB central unit/ng-eNB central unit (ng-eNB-CU, referred to as CU for short herein) and a gNB distributed unit/ng-eNB distributed unit (ng-eNB-DU, referred to as DU for short herein), as shown in FIG. 3c. FIG. 3c is a third example diagram of the base station structure. The ng-eNB-CU has an RRC layer and a PDCP layer. The gNB-DU/ng-eNB-DU has a radio link control (RLC) protocol layer, an MAC layer, a physical layer, etc. There is a standardized open interface W1 between the ng-eNB-CU and the ng-eNB-DU. The W1 interface is categorized into a control plane W1-C and a user plane W1-U. The transport network layer of the W1-C is based on IP transport. To realize more reliable transmission of signaling, an SCTP protocol is added on top of the IP. The protocol of the application layer is W1AP. The transport layer of the W1-U is UDP/IP, and the GTP-U is on top of the UDP/IP and configured for carrying a user plane protocol data unit (PDU).

In the 5G communication technology, since a higher frequency point is used, a higher transmission speed than 4G is obtained. However, a higher frequency point also leads to a shorter transmission distance, and thus more base stations will be deployed in the 5G network to ensure a desired coverage of the 5G network. However, in practice, in some areas, normal deployment of 5G base stations is not possible due to the environmental or cost factors. In view of this, an integrated access and backhaul (IAB) technology has been proposed, to address the problem that these areas cannot be covered by 5G base stations and to ensure normal communication by users. The establishment process of IAB network, as well as partial migration and the transmission procedure of data packets in the IAB network, has been determined, but more in-depth research is needed for mobile IAB nodes and full migration.

The IAB network consists of an IAB donor node, IAB nodes and user equipments (UEs). The IAB donor node includes two portions, i.e., the IAB donor centralized unit (IAB donor CU) and the IAB donor distributed unit (IAB donor DU), where multiple IAB donor DUs may be under one IAB donor CU. The IAB node consists of two portions, i.e., the IAB distributed unit (IAB node DU) and the IAB mobile termination (IAB node MT). The IAB node DU is connected to the IAB donor CU through the F1 interface, and the IAB node MT is connected to other IAB node DU through a Uu interface. The DU portion of the IAB node may also be connected to other user equipment (UE).

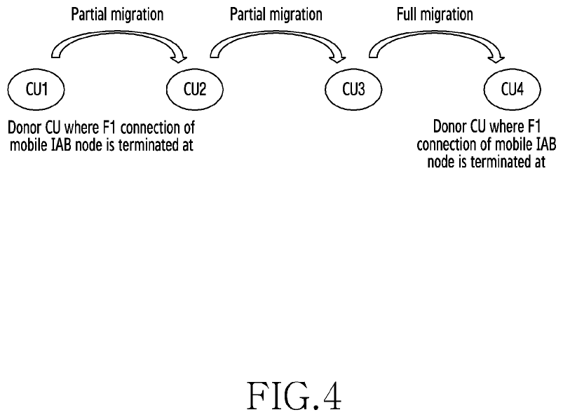

The partial migration process specifically is: when a migrating node is degraded in wireless performance, a source donor node (source IAB donor CU) may perform the partial migration according to a measurement report reported by the migrating node to partially migrate the radio resource control (RRC) signaling of the migrating node to a target path. In further research of the mobile IAB node, the migration of the F1 portion of the migrating node may be further studied based on the partial migration. Since partial migration is simpler and faster than full migration, both of the source IAB donor CU and the target donor node (target IAB donor CU) may tend to perform partial migration first to solve the problem of wireless performance degradation, and full migration may be performed only when the partial migration cannot solve the corresponding problem. Therefore, a situation may occur where the migrating node performs multiple partial migration first and then full migration, as shown in FIG. 4. FIG. 4 is an example diagram of performing multiple partial migration first and then full migration according to an embodiment of the present application.

In this case, the following problems may show up.
a) How to perform the multiple partial migration, that is, how to determine which target IAB donor CU the RRC connection is to be migrated to.
b) How to determine which target IAB donor CU the F1 is to be migrated to when the full migration is being performed.
c) How to migrate an F1 connection after it is determined that the F1 is to be migrated to a certain target IAB donor CU.

The technical problem mainly to be solved by the disclosure is to determine how the migrating node performs the multiple partial migration and how the migrating node performs the multiple partial migration first and then the full migration. The disclosure mainly relates to the following aspects.

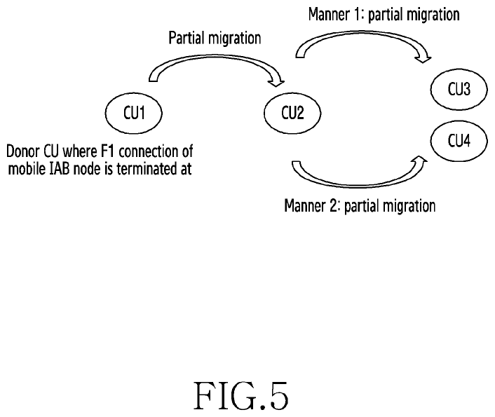

First, in the process of the multiple partial migration shown in FIG. 5. FIG. 5 illustrates an example for performing partial migration among multiple target IAB donor CUs according to an embodiment of the present disclosure:
1. Which network element determines which the target IAB donor CU the RRC connection of the migrating node is to be migrated to; and
2. How to migrate the RRC connection after it is determined that the RRC connection is to be migrated to the target IAB donor CU.

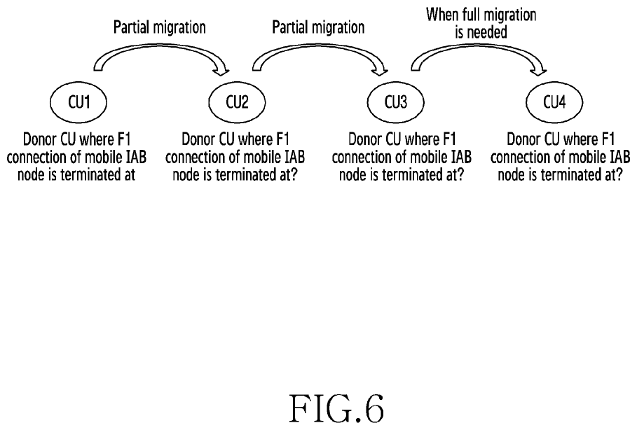

Second, in the process of the F1 migration shown in FIG. 6. FIG. 6 is an example diagram of performing F1 migration among multiple target IAB donor CUs according to an embodiment of the present application:
1. How to determine which the target IAB donor CU the F1 is to be migrated to when the F1 of the migrating node is needed to be migrated; and
2. How to perform the process of the F1 migration after it is determined that the F1 is to be migrated to the target IAB donor CU.

Before the presentation of the specific contents, some assumptions and some definitions of the disclosure will be given below.

The message names in the disclosure are only examples, and other message names are also possible.

The words “first,” “second,” etc. contained in the message names in the disclosure are only examples of messages, and do not represent the execution order.

Detailed description of steps irrelevant to the disclosure will be omitted in the disclosure.

In the disclosure, the steps in each procedure may be executed in combination or independently. The execution steps of each procedure are only examples, and other possible execution orders are not excluded.

In the disclosure, the base station may be a 5G base station (e.g., gNB, ng-eNB), or may be a 4G base station (e.g., eNB), or may be a 6G base station, or may be other types of access nodes.

In the disclosure, the transmission of data refers to receiving or sending data.

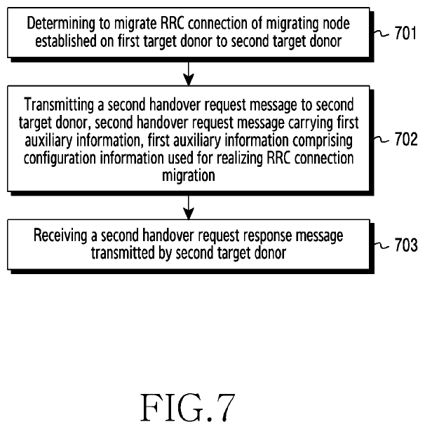

FIG. 7 illustrates a flowchart of a method performed by a first target donor node in a wireless communication system according to an embodiment of the present disclosure. The application provides a method performed by a first target donor node in a wireless communication system, as shown in FIG. 7, including the following steps:
701: determining to migrate an RRC connection of a migrating node established on the first target donor node to a second target donor node;
702: transmitting a second handover request message to the second target donor node, the second handover request message carrying first assistance information, and the first assistance information including configuration information used for realizing RRC connection migration; and
703: receiving a second handover request acknowledge message transmitted by the second target donor node.

In an optional solution, in 701, a donor list (target IAB donor CU list) is preconfigured for the first target donor node through operation administration and maintenance (OAM), and the first target donor node may select the second target donor node from this donor list based on reception of a measurement report reported by the migrating node (for example, the donor node with the highest RSRP is selected for partial migration of the migrating node). A donor node in the donor list may be a target donor node (target IAB donor CU) having an interface with the source donor node (source IAB donor CU).

In an optional solution, the second handover request acknowledge message carries the information on handover request acknowledge, and/or configuration information used for realizing RRC connection migration that is configured by the second target donor node.

The second target donor node may refer to the configuration information configured by the first assistance information used for realizing RRC connection migration carried in the second handover request message.

If the second handover request acknowledge message carries the information indicating that the second target donor node disagrees with handover, the first target donor node reselects, based on the measurement report, a donor node from the preconfigured donor list, for example, selecting a donor node with the second highest RSRP, to transmit the second handover request message.

In the solutions in the embodiments of the application, a first target donor node determines to migrate an RRC connection of a migrating node established on the first target donor node to a second target donor node and then transmits a handover request message to the second target donor node, and the handover request message carries first assistance information including configuration information used for realizing RRC connection migration, so that the partial migration can be enhanced to provide coverage.

In other embodiments, the method may further include: transmitting a first message to the migrating node, the first message including configuration information related to RRC connection migration that is configured by the second target donor node; receiving a first response message for the first message transmitted by the migrating node; and transmitting, to a source donor node, first indication information for indicating, to the source donor node, migrating the RRC connection of the migrating node to the second target donor node, the first indication information carrying configuration information used for realizing RRC connection migration that is configured by the second target donor node.

In this embodiment, the first target donor node determines to migrate the RRC connection of the migrating node established on the first target donor node to the second target donor node and transmits a handover request message to the second target donor node, the handover request message carrying first assistance information including configuration information used for realizing partial migration; upon receiving the handover request acknowledge message fed back by the second target donor node, the first target donor node transmits, to the migrating node, a first message including the configuration information related to RRC connection migration that is configured by the second target donor node; and upon receiving the first response transmitted by the migrating node, the first target donor node transmits, to the source donor node, first indication information for indicating, to the source donor node, migrating the RRC connection of the migrating node to the second target donor node, the first indication information carrying the configuration information used for realizing partial migration that is configured by the second target donor node, so that multiple RRC migration is realized.

It is to be noted that, in this embodiment, the first message may be an RRC reconfiguration message, the first response message may be an RRC reconfiguration complete message, and the first message and the first response message may also be newly defined messages. The names of the messages will not be limited in the embodiments of the application.

It is also to be noted that, in this embodiment, RRC connection migration is referred to migration of the RRC connection between the migrating node and the source donor node to a certain target donor node, that is, this RRC connection becomes the RRC connection between the migrating node and this target donor node after migration. For example, the RRC connection established on the source donor node is migrated to the first target donor node, and becomes the RRC connection between the migrating node and the first target donor node after migration; and then, the RRC connection established on the first target donor node is migrated to the second target donor node, and becomes the RRC connection between the migrating node and the second target donor node after migration. The RRC connection migration may also be referred to as RRC signaling migration, etc., and the name will not be limited in the application.

In other embodiments, before 702, the method further includes: transmitting, to the source donor node, second indication information for indicating, to the source donor node, migrating the RRC connection of the migrating node to the second target donor node; receiving a second message transmitted by the source donor node; transmitting the second handover request message to the second target donor node if the second message indicates acknowledgement of partial migration of the migrating node; and transmitting the second handover request message to a third target donor node if the second message indicates rejection of partial migration of the migrating node, wherein the second message carries a first target donor list, and the third target donor node can be determined based on the first target donor list.

In this embodiment, the first target donor node determines to migrate the RRC connection of the migrating node established on the first target donor node to the second target donor node, the first target donor node may transmit the second indication information to the source donor node for indicating to, the source donor node, migrating the RRC connection of the migrating node to the second target donor node; if the first target donor node receives a message indicating acknowledgement of partial migration of the migrating node transmitted by the source donor node, the first target donor node transmits the second handover request message to the second target donor node; if the first target donor node receives a message indicating rejection of partial migration of the migrating node transmitted by the source donor node, the first target donor node transmits the second handover request message to a third target donor node, wherein the third target donor node can be determined based on the first target donor list carried in the message indicating rejection. The second handover request message carries the first assistance information including the configuration information used for realizing RRC connection migration, so that the RRC connection migration can be realized.

In a possible example, the donor nodes in the first target donor node may be target donor nodes which the source donor node agrees the migrating node to be migrated to.

In other embodiments, the first target donor list further includes the priorities of the included target donor nodes, and the method further includes: determining, from the first target donor list, the third target donor node according to the priorities of the target donor nodes included in the first target donor list.

In this embodiment, if the first target donor node receives a message indicating rejection of partial migration of the migrating node transmitted by the source donor node, the target donor node with the highest priority may be selected as the third target donor node based on the priorities of the target donor nodes in the first target donor list carried in the message indicating rejection.

In other embodiments, before 701, the method further includes: receiving a first handover request message transmitted by the source donor node, the first handover request message being configured for requesting to migrate the RRC connection of the migrating node to the first target donor node, the first handover request message carrying a second target donor list; and determining the second target donor node according to the second target donor list.

In this embodiment, since the first handover request message transmitted by the source donor node carries the second target donor list, upon receiving the first handover request message, the first target donor node may determine the second target donor node based on the carried second target donor list, and migrate the RRC connection of the migrating node on the first donor node to the second target donor node.

In an optional solution, upon receiving the measurement report reported by the migrating node, the first target donor node may select, from the second target donor list, the second target donor node based on the RSRP of signals in surrounding donor nodes, for example, selecting a donor node with the highest RSRP.

In an optional solution, the donor nodes in the second target donor list may be donor nodes that have an Xn interface with the source donor node.

In an optional solution, the source donor node may add, in the handover request message transmitted to the first target donor node, third indication information for indicating the second target donor list.

In an optional solution, the second target donor list further includes the priorities of the included target donor nodes; and, if the first target donor node receives the first handover request message transmitted by the source donor node, the target donor node with the highest priority may be selected as the second target donor node based on the priorities of the target donor nodes in the second target donor list carried in this message.

The application provides a method performed by a source donor node in a wireless communication system, including: receiving indication information, transmitted by a first target donor node, for indicating, to the source donor node, migrating an RRC connection of a migrating node to a second target donor node determined by the first target donor node, the RRC connection of the migrating node being established on the first target donor node.

In an optional solution, the indication information (the above first indication information) carries the configuration information used for realizing RRC connection migration that is configured by the second target donor node.

In some examples, the method further includes: transmitting a first handover request message to the first target donor node, the first handover request message being configured for requesting to migrate the RRC connection of the migrating node to the first target donor node, the first handover request message carrying a second target donor list configured for determining the second target donor node.

In this embodiment, the source donor node may transmit, to the first target donor node, the first handover request message carrying the second target donor list, so that the first target donor node determines the second target donor node based on the second target donor list so as to realize the re-migration of the RRC connection.

In some examples, the method further includes: transmitting a second message to the first target donor node, the second message indicating acknowledgement of partial migration of the migrating node or indicating rejection of partial migration of the migrating node; wherein the second message carries a first target donor list configured for determining a third target donor node if the second message indicates rejection of partial migration of the migrating node.

In this embodiment, upon receiving the indication information transmitted by the first target donor node which indicates, to source donor node, migrating the RRC connection of the migrating node to the second target donor node determined by the first target donor node, the source donor node may transmit, to the first target donor node, a message indicating acknowledgement or rejection of partial migration of the migrating node; and, if the message indicating rejection of partial migration of the migrating node is transmitted, the first target donor list configured for determining the third target donor node is carried in the message indicating rejection, so that the first target donor node determines the third target donor node based on the first target donor list so as to realize RRC connection migration.

The application provides a method performed by a first target donor node in a wireless communication system, including: receiving a first measurement report transmitted by a migrating node migrated to the first target donor node; and transmitting the received first measurement report to a source donor node, the first measurement report being used by the source donor node to determine a second target donor node which the RRC connection of the migrating node is to be migrated to.

In this embodiment, if the RRC connection of the migrating node is established on the first target donor node, a measurement report reported by the migrating node is transmitted to the source donor node, so that the source donor node determines, based on this measurement report, the second target donor node which the RRC is to be re-migrated to.

In some examples, the method further includes: receiving fourth indication information, transmitted by the source donor node, for indicating, to the first target donor node, migrating the RRC connection of the migrating node to the second target donor node, the second target donor node being determined by the source donor node based on the first measurement report; transmitting a third handover request message to the second target donor node, the third handover request message carrying first assistance information, the first assistance information including configuration information used for realizing RRC connection migration; and receiving a third handover request acknowledge message transmitted by the second target donor node.

In this embodiment, if the RRC connection of the migrating node is established on the first target donor node, a measurement report reported by the migrating node is transmitted to the source donor node. After the source donor node determines, based on this measurement report, the second target donor node which the RRC is to be re-migrated to, the fourth indication information for indicating, to the first target donor node, migrating the RRC connection of the migrating node to the second target donor node may be transmitted to the first target donor node, and then the first target donor node may transmit a handover request message to the second target donor node, this handover request message carrying first assistance information including configuration information used for realizing RRC connection migration, so that multiple RRC migration can be realized.

In some examples, the method further includes: receiving a first request message transmitted by the source donor node, the first request message being configured for requesting the first target donor node to migrate the RRC connection of the migrating node to the second target donor node, the first request message carrying configuration information related to RRC connection migration that is configured by the second target donor node.

In this embodiment, if the RRC connection of the migrating node is established on the first target donor node, a measurement report reported by the migrating node is transmitted to the source donor node. After the source donor node determines, based on this measurement report, the second target donor node which the RRC is to be re-migrated to, a handover request process may be initiated to the second target donor node; and, after the handover request response fed back by the second target donor node is received, a first request message is transmitted to the first target donor node. The first request message is configured for requesting the first target donor node to migrate the RRC connection of the migrating node to the second target donor node, and carries the configuration information in the handover request response related to RRC connection migration that is configured by the second target donor node. Then, the first target donor node may perform RRC reconfiguration for the migrating node.

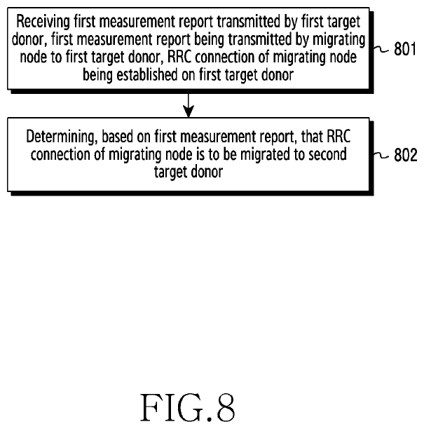

FIG. 8 illustrates a flowchart of a method performed by a source donor node in a wireless communication system according to an embodiment of the present disclosure. The application provides a method performed by a source donor node in a wireless communication system, as shown in FIG. 8, including:
801: receiving a first measurement report transmitted by a first target donor node, the first measurement report being transmitted to the first target donor node from a migrating node, an RRC connection of the migrating node being established on the first target donor node; and
802: determining, based on the first measurement report, that the RRC connection of the migrating node is to be migrated to a second target donor node.

In this embodiment, if the RRC connection of the migrating node is established on the first target donor node, a measurement report reported by the migrating node is transmitted to the source donor node, and the source donor node determines based on this measurement report that the RRC connection is to be migrated to the second target donor node, so that multiple RRC connection migration is realized.

In some examples, the method further includes: transmitting, to the first target donor node, fourth indication information for indicating, to the first target donor node, migrating the RRC connection of the migrating node to the second target donor node, the second target donor node being determined based on the first measurement report.

In this embodiment, if the RRC connection of the migrating node is established on the first target donor node, a measurement report reported by the migrating node is transmitted to the source donor node. After the source donor node determines based on the measurement report that the RRC connection is to be migrated to the second target donor node, the source donor node may transmit the fourth indication information to the first target donor node for indicating, to the first target donor node, migrating the RRC connection of the migrating node to the second target donor node, so that the first target donor node can initiate a handover request process to the second target donor node, and multiple migration RRC connection can be realized.

In some examples, the method further includes: transmitting a fifth handover request message to the second target donor node, the fifth handover request message carrying first assistance information, and the first assistance information including configuration information used for realizing RRC connection migration; receiving a fifth handover request acknowledge message transmitted by the second target donor node, the fifth handover request acknowledge message carrying configuration information related to RRC connection migration that is configured by the second target donor node; and transmitting a first request message to the first target donor node, the first request message being configured for requesting the first target donor node to migrate the RRC connection of the migrating node to the second target donor node, and the first request message carrying configuration information related to RRC connection migration that is configured by the second target donor node.

In this embodiment, if the RRC connection of the migrating node is established on the first target donor node, a measurement report reported by the migrating node is transmitted to the source donor node. After the source donor node determines based on the measurement report that the RRC connection is to be migrated to the second target donor node, the source donor node may initiate a handover request process to the second target donor node; and, after receiving the handover request response fed back by the second target donor node, the source donor node transmits a first request message to the first target donor node. The first request message is configured for requesting the first target donor node to migrate the RRC connection of the migrating node to the second target donor node, and carries the configuration information in the handover request response related to RRC connection migration that is configured by the second target donor node. Then, the first target donor node may perform RRC reconfiguration for the migrating node.

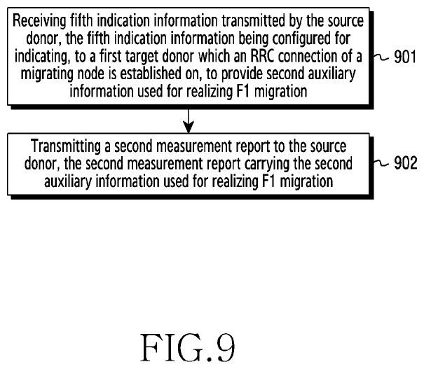

FIG. 9 illustrates a flowchart of a method performed by a first target donor node in a wireless communication system according to another embodiment of the present disclosure. The application provides a method performed by a first target donor node in a wireless communication system, as shown in FIG. 9, including:
901: receiving fifth indication information transmitted by the source donor node, the fifth indication information being configured for indicating, to the first target donor node which an RRC connection of a migrating node is established on, to provide second assistance information used for realizing F1 migration; and
902: transmitting a second measurement report to the source donor node, the second measurement report carrying the second assistance information used for realizing F1 migration.

In this embodiment, upon receiving the fifth indication information transmitted by the source donor node, the first target donor node transmits, to the source donor node, a measurement report carrying the second assistance information used for realizing F1 migration, so that the source donor node determines a target donor node which F1 of the migrating node is to be migrated to.

It should be understood that the solution in this embodiment may be a solution of determining the target donor node which F1 is to be migrated to in F1 migration after multiple RRC connection migration is realized based on the above embodiments.

It is to be noted that, in this embodiment, F1 migration refers to migration of the F1 connection between the migrating node and the source donor node to the determined target donor node, that is, this F1 connection becomes the F1 connection between the migrating node and this target donor node after migration.

In an optional solution, the second assistance information includes at least one of the following information:
information for indicating that the first target donor node is to migrate the migrating node;
location information of the migrating node within a preset time;
information of a prediction result of the movement direction of the migrating node; and
information for indicating the target donor node which the first target donor node is to migrate the migrating node to.

In other words, the first target donor node needs to inform the source donor node when it is to migrate the migrating node, or the first target donor node informs the source donor node of the location information of the migrating node within a period of time, or the first target donor node informs the source donor node of the prediction result of the movement direction of the migrating node, or the first target donor node informs the source donor node of the target donor node which the migrating node is to be migrated to, so that the source donor node determines, based on these information, the target donor node which F1 of the migrating node is to be migrated to.

In some examples, the method further includes: receiving a fourth handover request message transmitted by the source donor node, the fourth handover request message being configured for requesting to migrate F1 of the migrating node to the first target donor node; and transmitting, to the source donor node, a fourth handover request acknowledge message carrying the information on handover request acknowledge.

In this embodiment, if the source donor node determines that F1 of the migrating node is to be migrated to the first target donor node which the RRC connection is established on, the source donor node is to transmit, to the first target donor node, a handover request message for requesting to migrate F1 to the first target donor node; and, if the first target donor node agrees with handover, that is, the first target donor node agrees to migrate F1 to the first target donor node, the first target donor node feeds back a handover request acknowledge message carrying handover acknowledgment information to the source donor node to facilitate the subsequent F1 migration process.

In some examples, the method further includes: receiving eighth indication information, transmitted by the source donor node, for indicating migration of F1 of the migrating node to a fourth target node, the eighth indication information carrying configuration information related to F1 migration of the migrating node that is configured by the fourth target donor node, wherein the fourth target donor node is a donor node different from the first target donor node.

In this embodiment, if the source donor node determines that F1 of the migrating node is to be migrated to the fourth target donor node different from the first target donor node which the RRC connection is established on, upon receiving the handover request response fed back by the fourth target donor node, the source donor node transmits, to the first target donor node, the eighth indication information for indicating migration of F1 of the migrating node to the fourth target donor node, and adds, in the eighth indication information, the configuration information related to F1 migration of the migrating node that is configured by the fourth target donor node, so that F1 migration is realized.

In some examples, the method further includes: transmitting an acknowledgement message to the source donor node, the acknowledgement message carrying first configuration information, the first configuration information being configuration information related to partial migration that is configured by the first target donor node when F1 is terminated at the fourth target donor node and the RRC connection is terminated at the first donor node; or, transmitting first configuration information to the fourth target donor node, the first configuration information being configuration information related to partial migration that is configured by the first target donor node when F1 is terminated at the fourth target donor node and the RRC connection is terminated at the first donor node.

In this embodiment, upon receiving the eighth indication information transmitted by the source donor node for indicating migration of F1 of the migrating node to the fourth target donor node, the first target donor node may implement F1 migration by the following two manners.
Manner 1: the first target donor node feeds back an acknowledgement message to the source donor node, the first configuration information related to partial migration that is configured by the first target donor node when F1 is terminated at the fourth target donor node and the RRC connection is terminated at the first donor node being carried in the acknowledgement message, and the source node transmits the received first configuration information to the fourth target donor node through an Xn interface, so that F1 migration is realized.
Manner 2: the first target donor node directly transmits the first configuration information related to partial migration that is configured by the first target donor node when F1 is terminated at the fourth target donor node and the RRC connection is terminated at the first donor node to the fourth target donor node through an Xn interface, so that F1 migration is realized.

In some examples, the method further includes: receiving ninth indication information, transmitted by the source donor node, for indicating to, the first target donor node, migrating the RRC connection of the migrating node to the fourth target donor node, the ninth indication information carrying configuration information related to RRC connection migration that is configured by the fourth target donor node, wherein the fourth target donor node is a donor node different from the first target donor node.

In this embodiment, if the source donor node determines that F1 of the migrating node is to be migrated to the fourth target donor node different from the first target donor node which the RRC connection is established on, upon receiving the second response message fed back by the fourth target donor node, the source donor node transmits, to the first target donor node, the ninth indication information for indicating migrating F1 of the migrating node to the fourth target donor node, and adds, in the ninth indication information, the configuration information related to RRC migration that is configured by the fourth target donor node, so that F1 migration is realized.

The application further provides a method performed by a fourth target donor node in a wireless communication system, including: receiving a fourth handover request message transmitted by a source donor node, the fourth handover request message being configured for requesting to migrate F1 to the fourth target donor node, the fourth target donor node being a donor node different from a first target donor node which an RRC connection is established on; and transmitting, to the source donor node, a fourth handover request acknowledge message carrying the information on handover request acknowledge.

In this embodiment, if the source donor node determines that F1 is to be migrated to a donor node (called a fourth target donor node) different from the first target donor node which the RRC connection is established on, the source donor may transmit a handover request message to the fourth target donor for requesting to migrate F1 to the fourth target donor; and, if the fourth target donor node agrees with handover, that is, the fourth target donor node agrees to migrate F1 to the fourth target donor node, the fourth target donor node transmits a handover request acknowledge message carrying the information on handover request acknowledge to the source donor node.

In some examples, the method further includes: receiving first configuration information transmitted by the source donor node, the first configuration information being configuration information related to partial migration that is configured by the first target donor node when F1 is terminated at the fourth target donor node and the RRC connection is terminated at the first donor node.

In this embodiment, if the source donor node determines that F1 is to be migrated to the fourth target donor node different from the first target donor node which the RRC connection is established on, the source donor node transmits, to the fourth target donor node, a handover request message for requesting to migrate F1 to the fourth target donor node. If the fourth target donor node agrees with handover, the fourth target donor node feeds back a handover request acknowledge message carrying the information on handover request acknowledge to the source donor node. Upon receiving the handover request acknowledge message, the source donor node transmits, to the fourth target donor node, configuration information related to partial migration of the fourth target donor node when F1 is terminated at the fourth target donor node, to facilitate the subsequent F1 migration process.

The application further provides a method performed by a fourth target donor node in a wireless communication system, including: receiving a second request message transmitted by a source donor node, the second request message carrying related information required in the migration process of a migrating node; and transmitting a second response message to the source donor node, the second response message carrying configuration information used for realizing full migration that is configured by the first target donor node, and the fourth target donor node being a donor node different from a first target donor node which an RRC connection is established on.

In this embodiment, if the source donor node determines that the fourth target donor node which F1 of the migrating node is to be migrated to is different from the first target donor node which the RRC connection is established on, the source donor node transmits a second request message to the fourth target donor node, and the fourth target donor node configures, based on the related information required in the migration process of the migrating node carried in the second request message, configuration information used for realizing full migration and adds the configured information in a second response message for feedback to the source donor node.

It is to be noted that, in this embodiment, the second request message may be a full migration request message, the second response message may be a full migration response message, and the second request message and the second response message may also be newly defined messages. The names of the messages will not be limited in the embodiments of the application.

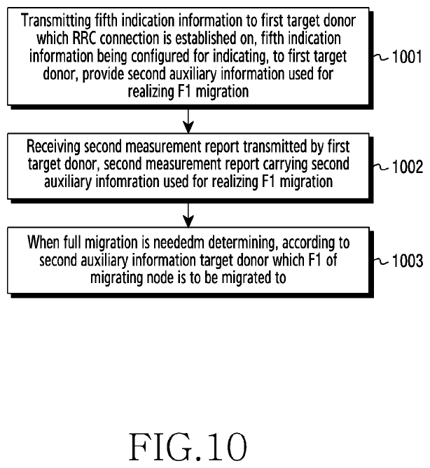

FIG. 10 illustrates a flowchart of a method performed by a source donor node in a wireless communication system according to an embodiment of the present disclosure. The application provides a method performed by a source donor node in a wireless communication system, as shown in FIG. 10, including:
1001: transmitting fifth indication information to a first target donor node which an RRC connection is established on, the fifth indication information being configured for indicating to, the first target donor node, to provide second assistance information used for realizing F1 migration;
1002: receiving a second measurement report transmitted by the first target donor node, the second measurement report carrying the second assistance information used for realizing F1 migration; and
1003: if full migration is to be performed, determining a target donor node which F1 of a migrating node is to be migrated to according to the second assistance information.

In this embodiment, the source node may transmit, to the first target donor node which the RRC connection is established on, fifth indication information for indicating, to the first target donor node, to provide second assistance information used for realizing F1 migration, and the first target donor node transmits, to the source donor node, a measurement report carrying the second assistance information used for realizing F1 migration. If the source donor node determines to perform full migration, the target donor node which F1 is to be migrated to may be determined according to the second assistance information in the measurement report.

It should be understood that the solution in this embodiment may be a solution of determining the target donor node which F1 is to be migrated to in F1 migration of the migrating node after multiple RRC connection migration is realized based on the above embodiments.

In some examples, the fifth indication information includes at least one of the following information: information for indication of informing the source donor node that the first target donor node is to migrate the migrating node; information for indication of informing the source donor node of location information of the migrating node within a preset time; information for indication of informing the source donor node of a prediction result of a movement direction of the migrating node; and information for indication of informing the source donor node of a target donor node which the first target donor node is to migrate the migrating node to.

After the donor node which F1 of the migrating node is to be migrated to is determined with the solution in the above embodiment, the F1 migration process may be realized according to the solutions in the following embodiments.

In some examples, the method further includes:
if F1 of the migrating node is to be migrated to the first target donor node, transmitting a fourth handover request message to the first target donor node, the fourth handover request message being configured for requesting to migrate F1 of the migrating node to the first target donor node; and
if a fourth handover request acknowledge message carrying the information on handover request acknowledge transmitted by the first target donor node is received, transmitting, to the migrating node, sixth indication information for trigging the migrating node to perform F1 migration.

In this embodiment, if the source donor node determines that F1 of the migrating node is to be migrated to the first target donor node which the RRC connection is established on, the source donor node transmits a fourth handover request message (configured for requesting to migrate F1 to the first target donor node) to the first target donor node; and, if the first target donor node agrees with handover, that is, the first target donor node agrees to migrate F1 to the first target donor node, the first target donor node feeds back a handover request acknowledge message carrying handover acknowledgment information to the source donor node, and the source donor node transmits sixth indication information to the migrating node to trigger the migrating node to perform F1 migration, so that the F1 migration is realized.

In some examples, the method further includes:
if F1 of the migrating node is to be migrated to a fourth target donor node, transmitting a fourth handover request message to the fourth target donor node, the fourth handover request message being configured for requesting to migrate F1 of the migrating node to the fourth target donor node, the fourth target donor node being a donor node different from the first target donor node;
if a fourth handover request acknowledge message carrying the information on handover request acknowledge transmitted by the fourth target donor node is received, transmitting, to the migrating node, seventh indication information for indicating, to the migrating node, to initiate F1 migration to the fourth target donor node; and
transmitting, to the first target donor node, eighth indication information for indicating migration of F1 of the migrating node to the fourth target donor node, the eighth indication information carrying configuration information related to F1 migration of the migrating node that is configured by the fourth target donor node.

In this embodiment, if the resource donor node determines that F1 of the migrating node is to be migrated to the fourth target donor node different from the first target donor node which the RRC connection is established on, the source donor node transmits, to the fourth target donor node, a handover request message for requesting to migrate F1 to the fourth target donor node. If the fourth target donor node agrees with handover, the fourth target donor node feeds back a handover request acknowledge message carrying the information on handover request acknowledge to the source donor node. The source donor node transmits, to the migrating node, seventh indication information for indicating, to the migrating node, to initiate F1 migration to the fourth target donor node; the source donor node transmits, to the first target donor node, eighth indication information for indicating migration of F1 of the migrating node to the fourth target donor node; and the source donor node adds, in the eighth indication information, configuration information related to F1 migration of the migrating node that is configured by the fourth target donor node, so that F1 migration is realized.

In some examples, the solution of the above embodiment further includes: receiving an acknowledgement message transmitted by the first target donor node, the acknowledgement message carrying first configuration information, the first configuration information being configuration information related to partial migration that is configured by the first target donor node when F1 is terminated at the fourth target donor node and the RRC connection is terminated at the first donor node; and transmitting the first configuration information to the fourth target donor node.

In this embodiment, upon receiving the eighth indication information (configured for indicating migration of F1 of the migrating node to the fourth target donor node) transmitted by the source donor node, the first target donor node feeds a response acknowledgement message back to the source donor node and adds first configuration information in the acknowledgement message. The first configuration information is configuration information related to partial migration that is configured by the first target donor node when F1 is terminated at the fourth target donor node and the RRC connection is terminated at the first donor node. The source donor node transmits the received first configuration information to the fourth target donor node through an Xn interface, so that F1 migration is realized.

In some examples, the method further includes:
if F1 is to be migrated to the fourth target donor node, transmitting a second request message to the fourth target donor node, the second request message carrying related information required in the migration process of the migrating node, and the fourth target donor node being a donor node different from the first target donor node; and
if a second response message is received from the fourth target donor node, transmitting, to the first target donor node, ninth indication information for indicating, to the first target donor node, migrating the RRC connection of the migrating node to the fourth target donor node.

In an optional solution, the second response message carries configuration information used for realizing full migration that is configured by the fourth target donor node, and the ninth indication information carries configuration information related to RRC connection migration that is configured by the fourth target donor node.

In this embodiment, if the source donor node determines that F1 is to be migrated to the fourth target donor node different from the first target donor node which the RRC connection is established on, the source donor node transmits a second request message to the fourth target donor node, and adds, in this message, the related information required in the migration process of the migrating node. If the fourth target donor node agrees with handover, the fourth target donor node feeds back corresponding second response message to the source door, and the source donor node transmits, to the first target donor node, ninth indication information for indicating migration of F1 of the migrating node to the fourth target donor node and adds, in the ninth indication information, configuration information related to RRC connection migration that is configured by the fourth target donor node, so that F1 migration is realized.

The technical solutions in the embodiments of the application will be described below in detail with reference to specific embodiments.

In the following embodiments, the source IAB donor CU may correspond to the above source donor node, the target IAB donor CU1 may correspond to the above first target donor node, the target IAB donor CU2 may correspond to the above second target donor node, the target IAB donor CU3 may correspond to the above third target donor node, and the target IAB donor CU4 may correspond to the above fourth target donor node. For the sake of brevity, they will not be described in detail hereinafter.

It is to be noted that the message names in the following embodiments are only examples, and newly defined messages are also possible. This will not be limited in the embodiments of the application.

First aspect: how to determine the target IAN donor CU to be migrated and perform multiple partial migration.

### Embodiment 1

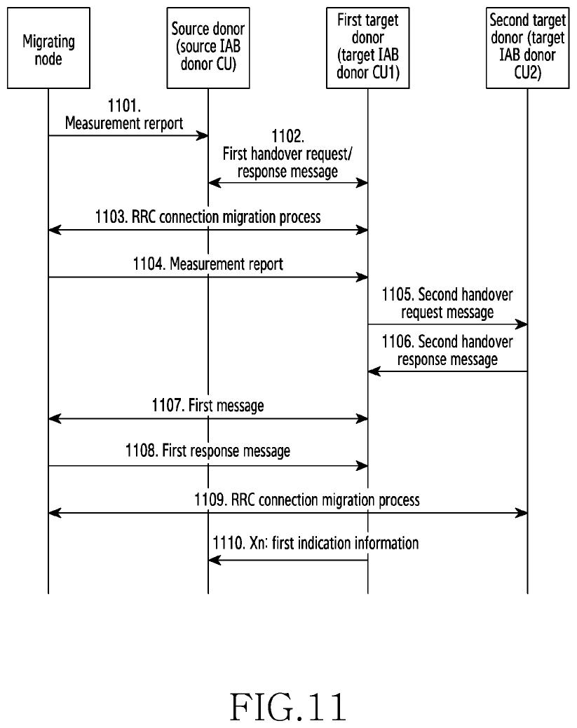

FIG. 11 illustrates a flowchart of determining, by a target IAB donor CU which an RRC connection is established on, a next target IAB donor CU according to an embodiment of the present disclosure. The specific process of determining, by the central unit of the target IAB donor node (target IAB donor CU) which the RRC connection is established on, the CU of a next target IAB donor node (next target IAB donor CU) includes the following steps, as shown in FIG. 11.

In 1101, a migrating node on the source path transmits a measurement report to a CU of a source IAB donor node (source IAB donor CU).

In 1102, the source IAB donor CU (which may correspond to the above-mentioned source donor node) determines, according to the measurement report, to migrate an RRC connection of the migrating node to a target IAB donor CU1 (which may correspond to the above-mentioned first target donor node), and initiates a handover procedure to the target IAB donor CU1.

In 1103, the migrating node migrates the RRC connection to the target IAB donor CU1 to perform a partial migration process. The RRC connection migration may also be regarded as IAB-MT migration or MT handover.

In 1104, after the RRC is migrated by the migrating node, the migrating node starts to report a measurement report to the target IAB donor CU1.

In 1105, when the target IAB donor CU1 determines, according to the measurement report, to re-migrate the RRC of the migrating node to a target IAB donor CU2 (which may correspond to the above-mentioned second target donor node), the target IAB donor CU1 adds first assistance information in a handover request and transmits the handover request to the target IAB donor CU2.

The first assistance information may be configuration information of the backhaul (BH) radio link control (RLC) channel and the backhaul adaptation protocol (BAP) routing and mapping rules that is provided by the target IAB donor CU for realizing partial migration, which intends to help the target IAB donor CU2 to implement the above configurations.

In an optional solution, the OAM may inform the target IAB donor CU1 of a target IAB donor CU list interfacing with the source IAB donor CU, so that the target IAB donor CU1 can directly select, from the list, the most suitable next target IAB donor CU for partial migration of the migrating node.

Here, the most suitable next target IAB donor CU may be a target IAB donor CU with the best signal that is selected from the target IAB donor CU list based on the received measurement report by the target IAB donor CU1.

In 1106, the target IAB donor CU2 transmits a handover request response (handover request ACK) to the target IAB donor CU1. The handover request ACK indicates to the target IAB donor CU1 that the handover request is agreed, and carries the configuration information of the BH RLC channel and the BAP routing and mapping rules provided by the target IAB donor CU2.

In 1107, upon receiving the handover request ACK from the target IAB donor CU2, the target IAB donor CU1 transmits a first message (e.g., an RRC reconfiguration message) to the migrating node for RRC reconfiguration.

In 1108, the migrating node transmits a first response message (e.g., an RRC reconfiguration complete message) to the target IAB donor CU1.

In 1109, the migrating node initiates a partial migration procedure to migrate the RRC connection from the target IAB donor CU1 to the target IAB donor CU2.

In 1110, the target IAB donor CU1 transmits first indication information to the source IAB donor CU through an Xn interface to indicate, to the source IAB donor CU, migrating the RRC connection of the migrating node to the target IAB donor CU2.

The first indication information is configured for indicating the related configuration information of the F1 connection with migrating node of the source IAB donor CU under the target IAB donor CU2, including the configurations of the BH RLC channel and the BAP routing and mapping rules. Thus, the source IAB donor CU can perform F1 data transmission under target path controlled by the target IAB donor CU2.

### Embodiment 2

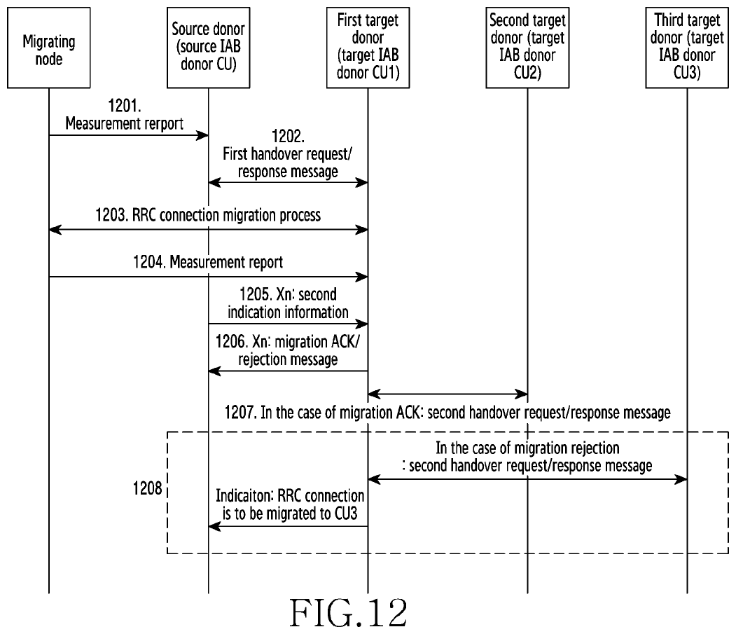

FIG. 12 illustrates a first flowchart of assisting, by a source IAB donor CU, a target IAB donor CU in determining a next Target donor CU according to an embodiment of the present disclosure. The specific process of assisting, by a source IAB donor CU, a target IAB donor CU to determine a next target IAB donor CU includes the following steps, as shown in FIG. 12.

In 1201, a migrating node under a source path transmits a measurement report to the source IAB donor CU.

In 1202, the source IAB donor CU determines, according to the measurement report, to migrate an RRC connection of the migrating node to a target IAB donor CU1, and initiates a handover procedure to the target IAB donor CU1.

In 1203, the migrating node migrates the RRC connection to the target IAB donor CU1 to perform a partial migration process.

In 1204, after the RRC is migrated by the migrating node, the migrating node starts to report a measurement report to the target IAB donor CU1.

In 1205, when the target IAB donor CU1 determines, according to the measurement report, to re-migrate the RRC of the migrating node to a target IAB donor CU2, the target IAB donor CU1 transmits second indication information to the source IAB donor CU through an Xn interface.

The second indication information informs the source IAB donor CU that the RRC connection of the migrating node is to be migrated to the target IAB donor CU2.

In 1206, the source IAB donor CU returns a second message (e.g., the corresponding migration ACK/reject message) to the target IAB donor CU1 through an Xn interface.

If the source IAB donor CU agrees with migration, the source IAB donor CU returns a migration ACK message.

If the source IAB donor CU disagrees with migration, the source IAB donor CU returns migration reject message, which carries the corresponding target IAB donor CU list (which may correspond to the above-mentioned first target donor list).

Optionally, this list is a list of target IAB donor CUs which the source IAB donor CU agrees the migrating node to migrate to.

Optionally, this list may carry priorities, and the migrating node is preferentially migrated to a target IAB donor CU with the highest priority.

In 1207, when the source IAB donor CU agrees to migrate the RRC connection of the migrating node to the target IAB donor CU2, the target IAB donor CU1 initiates a handover procedure to the target IAB donor CU2. The subsequent specific procedure may refer to 1205 to 1210 in Embodiment 1.

In 1208, when the source IAB donor CU disagrees to migrate the RRC connection of the migrating node to the target IAB donor CU2, the target IAB donor CU1 initiates a handover procedure to a target IAB donor CU3 (which may correspond to the above-mentioned third target donor node) according to the list. The subsequent specific procedure may refer to 1205 to 1210 in Embodiment 1.

### Embodiment 3

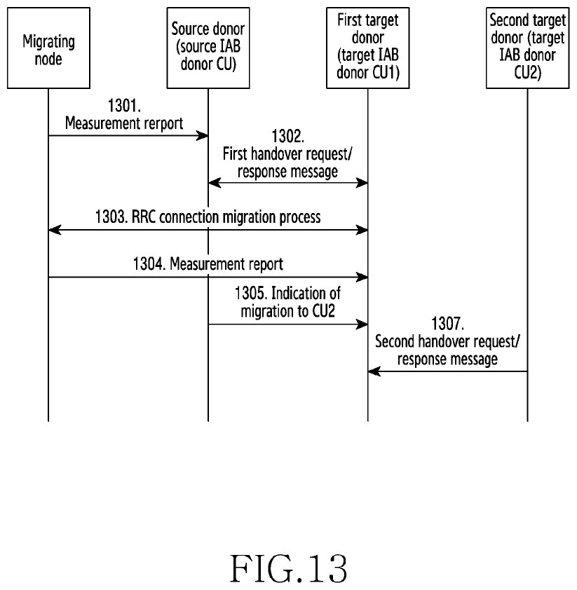

FIG. 13 illustrates a second flowchart of assisting, by a source IAB donor CU, a target IAB donor CU in determining a next Target donor CU according to an embodiment of the present disclosure. The specific process of assisting, by a source IAB donor CU, a target IAB donor CU to determine a next target IAB donor CU includes the following steps, as shown in FIG. 13.

In 1301, a migrating node under a source path transmits a measurement report to the source IAB donor CU.

In 1302, the source IAB donor CU determines, according to the measurement report, to migrate an RRC connection of the migrating node to a target IAB donor CU1, initiates a handover procedure to the target IAB donor CU1, and adds third indication information in a handover request (which may correspond the above-mentioned first handover request message) transmitted to the target IAB donor CU1.

Optionally, the third indication information informs the target IAB donor CU1 of the target IAB donor CU list having an Xn interface with the source IAB donor CU (which may be the above-mentioned second target donor list).

In 1303, the migrating node migrates the RRC connection to the target IAB donor CU1 to perform a partial migration process.

In 1304, after the RRC is migrated by the migrating node, the migrating node starts to report a measurement report to the target IAB donor CU1.

In 1305, when the target IAB donor CU1 determines to re-migrate the RRC of the migrating node according to the measurement report, the target IAB donor CU1 selects, according to the list in the third indication information, a target IAB donor CU2 which the RRC is to be migrated to, and informs the source IAB donor CU of the target IAB donor CU2 through an Xn interface.

As an example, the target IAB donor CU2 is selected from the list in the third indication information based on the RSRP values of surrounding IAB nodes measured by the migrating node.

In 1306, the target IAB donor CU1 initiates a handover procedure to the target IAB donor CU2. The subsequent specific procedure may refer to 1305 to 1310 in Embodiment 1.

### Embodiment 4

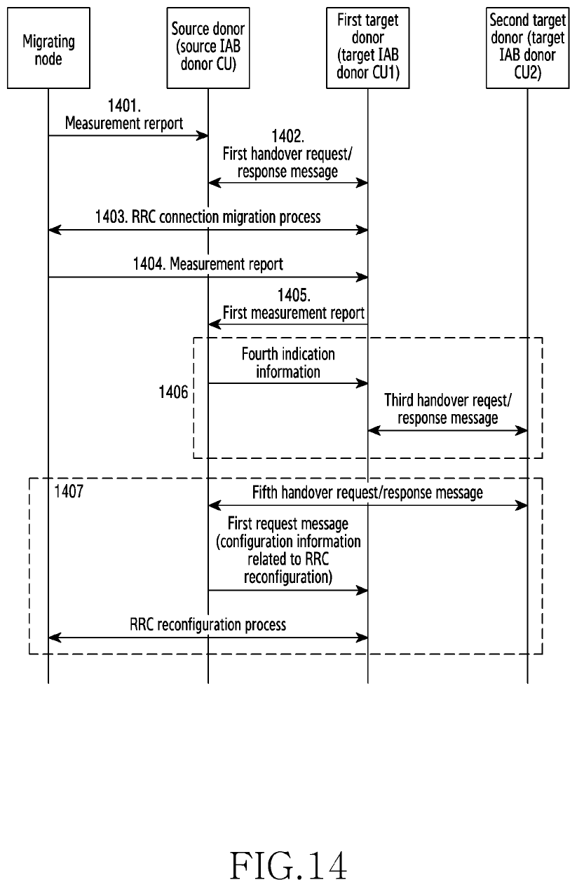

FIG. 14 illustrates a flowchart of determining, by a source IAB donor CU, a next Target donor CU according to an embodiment of the present disclosure. The specific process of determining a next target IAB donor CU by a source IAB donor CU includes the following steps, as shown in FIG. 14.

In 1401, a migrating node under a source path transmits a measurement report to the source IAB donor CU.

In 1402, the source IAB donor CU determines, according to the measurement report, to migrate an RRC connection of the migrating node to a target IAB donor CU1, and initiates a handover procedure to the target IAB donor CU1.

In 1403, the migrating node migrates the RRC connection to the target IB donor CU1 to perform a partial migration process.

In 1404, after the RRC is migrated by the migrating node, the migrating node starts to report a measurement report to the target IAB donor CU1.

In 1405, upon receiving the measurement report (which may correspond to the above first measurement report), the target IAB donor CU1 forwards the measurement report to the source IAB donor CU.

In 1406, when the source IAB donor CU determines, according to the received measurement report, to migrate the RRC connection of the migrating node to a target IAB donor CU2, there are two executable procedures, i.e., 1406 and 1407. Specifically:

In 1406, the source IAB donor CU directly transmits fourth indication information to the target IAB donor CU1 through an Xn interface. The fourth indication information indicates, to the target IAB donor CU1, migrating the RRC connection of the migrating node to the target IAB donor CU2.

Upon receiving the fourth indication information, the target IAB donor CU1 starts to initiate a handover procedure to the target IAB donor CU2 (the messages involved in this procedure may correspond to the above-mentioned third handover request message and third handover response message). The specific procedure may refer to 1105 to 1110 in Embodiment 1.

In 1407, the source IAB donor CU directly initiates a handover procedure to the target IAB donor CU2 through an Xn interface. The specific procedure may include the following steps.

The source IAB donor CU directly transmits a handover request (which may correspond to the above-mentioned fifth handover request message) to the target IAB donor CU2 through an Xn interface, and adds first assistance information in the handover request.

The target IAB donor CU2 transmits a handover request response (handover request ACK, which may correspond to the above-mentioned fifth handover response message) to the source IAB donor CU. The handover request response indicates to the source IAB donor CU that the handover request is agreed, and carries the configuration information which is provided by the target IAB donor CU2 and related to RRC connection migration, e.g., the configuration information of the BH RLC channel and the BAP routing and mapping rules.

Upon receiving the RRC configuration message (e.g., handover request ACK (the handover request ACK carries the configuration information related to RRC connection migration) message), the source IAB donor CU transmits the RRC configuration message (which may correspond to the above-mentioned first request message) to the target IAB donor CU1 through an Xn interface.

The target IAB donor CU1 performs RRC reconfiguration for the migrating node through the RRC reconfiguration message.

Second aspect: how to determine a donor CU where F1 is located (F1 termination donor CU).

### Embodiment 5

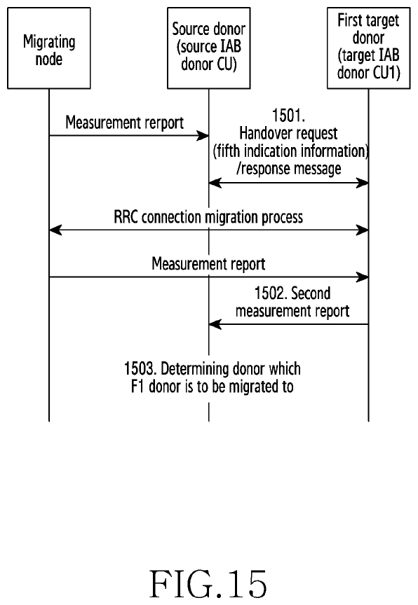

Since F1 is terminated at the source IAB donor CU, the source IAB donor CU needs to make a decision on the migration of F1, but it is difficult for the source IAB donor CU to make a proper decision. Since the measurement report of the migrating node is reported to the target IAB donor CU after the RRC is migrated, the related configuration of the measurement is also configured for the migrating node by the target IAB donor CU. Therefore, in F1 migration, in a case where the target IAB donor CU provides assistance information, the source IAB donor CU can make a more proper decision. The specific process includes the following steps, as shown in FIG. 15. FIG. 15 is a schematic flowchart of assisting, by a target IAB donor CU, a source IAB donor CU in determining an F1 termination donor CU according to an embodiment of the present application.

In 1501, the source IAB donor CU adds fifth indication information to a target IAB donor CU1 in the handover procedure (e.g., in the handover request). The indication information may be one or more of the following.
Indication 1: if the target IAB donor CU1 believes that the migrating node still needs to be migrated (which may be partial or full migration), the source IAB donor CU needs to be informed.
Indication 2: based on the indication 1, informing the source IAB donor CU that: the location of the migrating node within a certain time threshold needs to be carried when the migrating node needs to be re-migrated.
Indication 3: informing the source IAB donor CU of the prediction result of the movement direction of the migrating node.
Indication 4: informing the source IAB donor CU of which target IAB donor CU the target IAB donor CU1 is to migrate the migrating node to.

In 1502, the target IAB donor CU1 adds the above information in the measurement report (which may correspond to the above second measurement report) and transmits the information to the source IAB donor CU.

In 1503, the source IAB donor CU determines, according the related information, which target donor CU the F1 is to be migrated to if full migration is performed.

The related information may include the above indications 1 to 4 and the measurement report. Specifically:

According to the indication 1, the source IAB donor CU can know that the migrating node is to be migrated to another target IAB donor CU.

According to the indication 2, the source IAB donor CU can determine the movement trajectory of the migrating node.

According to the indication 3, the target IAB donor CU transmits the prediction result of the movement direction of the migrating node to the source IAB donor CU.

According to the indication information 2 and 3, the source IAB donor CU can determine which target IAB donor CUs are in the path.

According to the indication 4, the target IAB donor CU which the migrating node often moves under and whether the target IAB donor CU has an interface with the source IAB donor CU are recorded.

Third aspect: how to migrate F1.

After the source IAB donor CU determines the target IAB donor CU which F1 is to be migrated to, the next problem is how to migrate F1.

### Embodiment 6

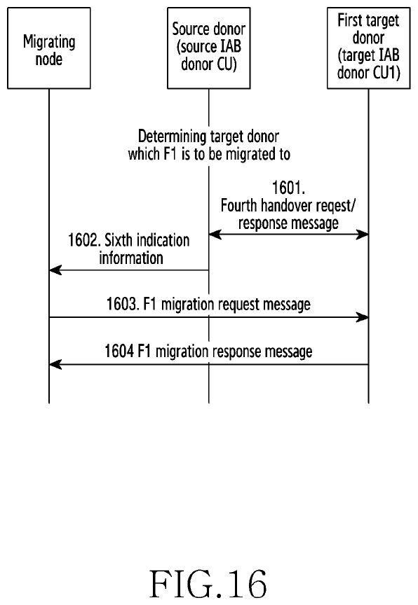

FIG. 16 illustrates a flowchart of migrating F1 to a target IAB donor CU which an RRC connection is established on according to an embodiment of the present disclosure. The specific process of migrating F1 to the target IAB donor CU which the RRC connection is established on includes the following steps, as shown in FIG. 16.

In 1601, after the source IAB donor CU determines an F1 termination donor CU, if F1 is also migrated to the target IAB donor CU (corresponding to the above first target donor node) which the RRC connection is established on, the source IAB donor CU initiates an F1 handover procedure to the target IAB donor CU1. This procedure includes the following steps.

The source IAB donor CU first transmits an F1 handover request (which may correspond to the above fourth handover request message) to the target IAB donor CU1 to request to migrate F1 to the target IAB donor CU1.

If the target IAB donor CU1 agrees with F1 migration, the target IAB donor CU1 returns an F1 handover request ACK (which may correspond to the above fourth handover request message) to the source IAB donor CU.

In 1602, upon receiving the handover request ACK from the target IAB donor CU1, the source IAB donor CU transmits sixth indication information (F1 handover to Target donor CU1) to the migrating node to trigger the migrating IAB node DU to perform the F1 migration process (F1 setup procedure).

In 1603, the migrating IAB node DU transmits an F1 migration request (F1 setup request) to the target IAB donor CU1.

In 1604, the target IAB donor CU1 returns an F1 migration response (F1 setup response) to the migrating node.

The migrating node only performs partial migration at first and does not know that the source IAB donor CU may let the migrating node perform full migration, so the source IAB donor CU needs to request F1 migration to the target IAB donor CU1 and then transmit indication information to the migrating node to trigger the DU to perform the F1 migration process.

### Embodiment 7

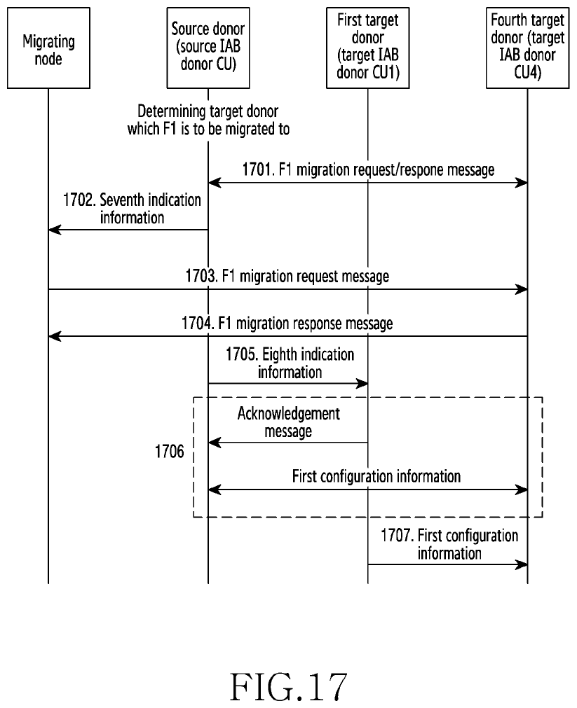

FIG. 17 illustrates an example of migrating F1 to a target IAB donor CU which RRC connection is not established on according to an embodiment of the present disclosure. The specific process of migrating F1 to the target IAB donor CU which RRC connection is not established on includes the following steps, as shown in FIG. 17.

In 1701, after the source IAB donor CU determines an F1 termination donor CU, if F1 is migrated to a target IAB donor CU4 (corresponding to the above fourth target donor node) which RRC connection is not established on, the source IAB donor CU transmits an F1 migration request to the target IAB donor CU4 to trigger an F1 migration procedure (the specific procedure is as described in the step S1701 in Embodiment 6).

In 1702, the source IAB donor CU transmits seventh indication information (F1 handover to target IAB donor CU4) to a migrating IAB node DU to indicate, to the migrating IAB node DU, to initiate an F1 setup procedure to the target IAB donor CU4.

In 1703, the migrating IAB node transmits an F1 setup request to the target IAB donor CU4.

In 1704, the target IAB donor CU4 transmits an F1 setup response to the migrating IAB node.

In 1705, the source IAB donor CU transmits eighth indication information (F1 handover to target IAB donor CU4) to a target IAB donor CU1 (corresponding to the above first target donor node) to inform the target IAB donor CU1 to migrate the F1 connection of the migrating node to the target IAB donor CU4, and carries the F1 related configuration information provided by the target IAB donor CU4.

The subsequent procedure may be completed by 1706 and 1707, specifically:

In 1706, upon receiving the eighth indication information, the target IAB donor CU1 returns F1 handover to CU4 ACK (which may correspond to the above acknowledgement message) to the source IAB donor CU, and carries the partial migration related configuration information of the BH RLC channel and the BAP routing and mapping rules when F1 is terminated at the target IAB donor CU4.

The source IAB donor CU then transmits the configuration information to the target IAB donor CU4 to perform reconfiguration of the BH RLC channel and the BAP routing and mapping rules related to the partial migration when F1 is terminated at the target IAB donor CU4 and the RRC donor node is terminated at the target IAB donor CU1.

In 1707, the target IAB donor CU1 directly transmits the configuration information of the BH RLC channel and the BAP configuration info to the target IAB donor CU4, to perform the reconfiguration of the BH RLC channel and the BAP routing and mapping rules when F1 is terminated at the target IAB donor CU4 and the RRC donor node is terminated at the target IAB donor CU1.

### Embodiment 8

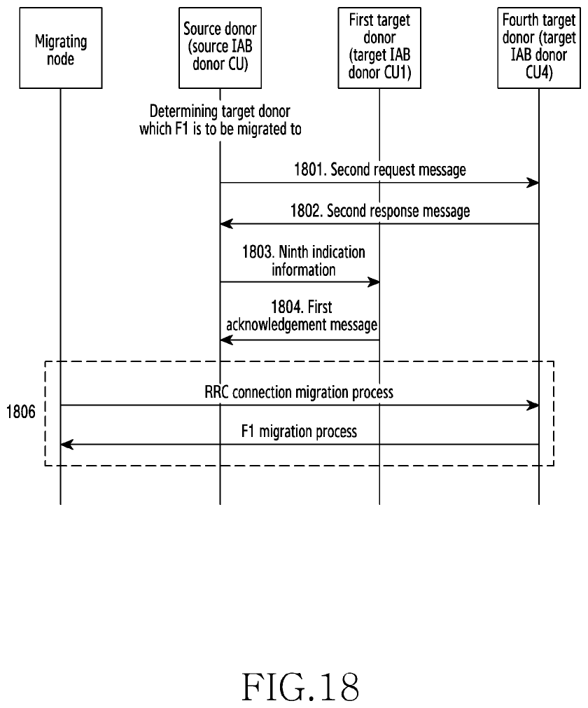

FIG. 18 illustrates an example of migrating both F1 and RRC to a target IAB donor CU which RRC connection is not established on according to an embodiment of the present disclosure. The specific process of migrating both F1 and RRC to a target IAB donor CU which RRC connection is not established on includes the following steps, as shown in FIG. 18.

In 1801, after the source IAB donor CU determines an F1 termination donor CU, if it is determined to migrate both F1 and RRC to a target IAB donor CU4 which the RRC connection is not established on, the source IAB donor CU transmits a second request message (e.g., full migration request) to the target IAB donor CU4, and carries the related information required in the migration process of the migrating node.

The related information required in the migration process of the migrating node may include: the related configuration information when the target IAB donor CU1 performs partial migration, the configuration information of the migrating node under the source CU, the context information of the UE served by the migrating node, the configuration information of F1 under the source CU, and other configuration information.

In 1802, the target IAB donor CU4 informs the source IAB donor CU the corresponding configuration information (which includes the configuration information related to RRC connection migration, or may also include F1 related configuration information) through a second response message (e.g., full migration response).

The corresponding configuration information provided by the target IAB donor CU4 is provided based on the related information required in the migration process of the migrating node.

In 1803, the source IAB donor CU transmits ninth indication information (e.g., RRC reconfiguration request) to the target IAB donor CU1. The ninth indication information carries the configuration information which is configured by the target IAB donor CU4 and related to RRC connection migration.

The ninth indication information is configured for indicating, to the target IAB donor CU1, migrating the RRC connection of the migrating node to the target IAB donor CU4.

Optionally, the ninth indication information is configured for indicating that the migrating node is to perform full migration and be migrated to the target IAB donor CU4. If the target IAB donor CU1 receives this indication, the target IAB donor CU1 can know that the RRC connection of the migrating node is to be migrated to the target IAB donor CU4.

In 1804, the target IAB donor CU1 returns an RRC reconfiguration ACK (which may correspond to the first acknowledgement message in the drawings) through an RRC reconfiguration response.

In 1805, the target IAB donor CU1 transmits a first message (e.g., RRC reconfiguration) to the migration node for RRC reconfiguration.

In 1806, upon receiving the RRC reconfiguration, the migrating node performs IAB-MT migration (e.g., RRC connection migration) first and then F1 migration.

It is to be noted that the above first, second and third aspects can be combined to form an integral process of performing multiple partial migration first, then determining an F1 termination CU and finally performing F1 migration.

An embodiment of the application provides an electronic device, including: a transceiver, which is configured to transmit and receive signals; and, a processor, which is coupled to the transceiver and configured to control to implement the steps in the above method embodiments.

Optionally, the electronic device may be a first target donor node, and the processor in the electronic device is configured to control to implement the steps in the method performed by a first target donor node provided in the above method embodiments.

Optionally, the electronic device may be a source donor node, and the processor in the electronic device is configured to control to implement the steps in the method performed by a source donor node provided in the above method embodiments.

Optionally, the electronic device may be a fourth target donor node, and the processor in the electronic device is configured to control to implement the steps in the method performed by a fourth target donor node provided in the above method embodiments.

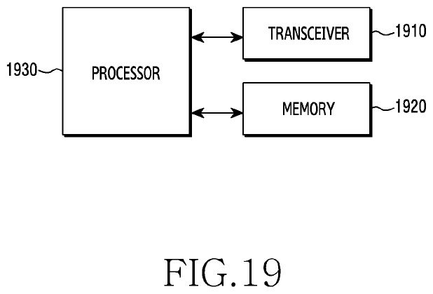

FIG. 19 illustrates a donor node according to an embodiment of the present disclosure. As shown in FIG. 19, the donor node shown in FIG. 19 includes a processor 1930 and a memory 1920. The processor 1930 is connected to the memory 1920, for example, through a bus. Optionally, the donor node may further include a transceiver 1910 configured for data interaction between the electronic device and other electronic devices (for example, transmission and/or reception of data). It should be noted that, in practical applications, the transceiver 1910 is not limited to one, and the structure of the donor node does not constitute any limitations to the embodiments of the application.

The processor 1930 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present disclosure. The processor 1930 may also be a combination for realizing computing functions, for example, a combination of one or more microprocessors, a combination of a DSP and a microprocessor, etc.

The bus may include a path to transfer information between the components described above. The bus may be a peripheral component interconnect (PCI) bus, or an extended industry standard architecture (EISA) bus, etc. The bus may be an address bus, a data bus, a control bus, etc. For ease of presentation, the bus is represented by only one thick line in FIG. 11. However, it does not mean that there is only one bus or one type of buses.

The memory 1920 may be read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store computer programs and that can be accessed by computers, which is not limited herein.

The memory 1920 is used to store computer programs for executing the embodiments of the application, and is controlled by the processor 1930. The processor 1930 is used to execute the computer programs stored in the memory 1920 to implement the steps shown in the above method embodiments.

FIG. 20 illustrates a structure of a UE according to an embodiment of the present disclosure.

As shown in FIG. 20, the UE according to an embodiment may include a transceiver 2010, a memory 2020, and a processor 2030. The transceiver 2010, the memory 2020, and the processor 2030 of the UE may operate according to a communication method of the UE described above. However, the components of the UE are not limited thereto. For example, the UE may include more or fewer components than those described above. In addition, the processor 2030, the transceiver 2010, and the memory 2020 may be implemented as a single chip. Also, the processor 2030 may include at least one processor. Furthermore, the UE of FIG. 20 corresponds to the UE 101, 102 of the FIGS. 1 and 2.

The transceiver 2010 collectively refers to a UE receiver and a UE transmitter, and may transmit/receive a signal to/from a base station or a network entity. The signal transmitted or received to or from the base station or a network entity may include control information and data. The transceiver 2010 may include a RF transmitter for up-converting and amplifying a frequency of a transmitted signal, and a RF receiver for amplifying low-noise and down-converting a frequency of a received signal. However, this is only an example of the transceiver 2010 and components of the transceiver 2010 are not limited to the RF transmitter and the RF receiver.

Also, the transceiver 2010 may receive and output, to the processor 2030, a signal through a wireless channel, and transmit a signal output from the processor 2030 through the wireless channel.

The memory 2020 may store a program and data required for operations of the UE. Also, the memory 2020 may store control information or data included in a signal obtained by the UE. The memory 2020 may be a storage medium, such as read-only memory (ROM), random access memory (RAM), a hard disk, a CD-ROM, and a DVD, or a combination of storage media.

The processor 2030 may control a series of processes such that the UE operates as described above. For example, the transceiver 2010 may receive a data signal including a control signal transmitted by the base station or the network entity, and the processor 2030 may determine a result of receiving the control signal and the data signal transmitted by the base station or the network entity.

FIG. 21 illustrates a structure of a base station according to an embodiment of the present disclosure.

As shown in FIG. 21, the base station according to an embodiment may include a transceiver 2110, a memory 2120, and a processor 2130. The transceiver 2110, the memory 2120, and the processor 2130 of the base station may operate according to a communication method of the base station described above. However, the components of the base station are not limited thereto. For example, the base station may include more or fewer components than those described above. In addition, the processor 2130, the transceiver 2110, and the memory 2120 may be implemented as a single chip. Also, the processor 2130 may include at least one processor. Furthermore, the base station of FIG. 21 corresponds to the E-UTRAN 102 and NG-RAN 202 of the FIGS. 1 and 2, respectively.

The transceiver 2110 collectively refers to a base station receiver and a base station transmitter, and may transmit/receive a signal to/from a terminal (UE) or a network entity. The signal transmitted or received to or from the terminal or a network entity may include control information and data. The transceiver 2110 may include a RF transmitter for up-converting and amplifying a frequency of a transmitted signal, and a RF receiver for amplifying low-noise and down-converting a frequency of a received signal. However, this is only an example of the transceiver 2110 and components of the transceiver 2110 are not limited to the RF transmitter and the RF receiver.

Also, the transceiver 2110 may receive and output, to the processor 2130, a signal through a wireless channel, and transmit a signal output from the processor 2130 through the wireless channel.

The memory 2120 may store a program and data required for operations of the base station. Also, the memory 2120 may store control information or data included in a signal obtained by the base station. The memory 2120 may be a storage medium, such as read-only memory (ROM), random access memory (RAM), a hard disk, a CD-ROM, and a DVD, or a combination of storage media.

The processor 2130 may control a series of processes such that the base station operates as described above. For example, the transceiver 2110 may receive a data signal including a control signal transmitted by the terminal, and the processor 2130 may determine a result of receiving the control signal and the data signal transmitted by the terminal.

An embodiment of the application further provides a first target donor node in a wireless communication system, including: a transceiver and a controller coupled to the transceiver, the controller being configured to execute the steps in the method embodiments performed by a first target donor node.

An embodiment of the application further provides a source donor node in a wireless communication system, including: a transceiver and a controller coupled to the transceiver, the controller being configured to execute the steps in the method embodiments performed by a source donor node.

An embodiment of the application further provides a fourth target donor node in a wireless communication system, including: a transceiver and a controller coupled to the transceiver, the controller being configured to execute the steps in the method embodiments performed by a fourth target donor node.

Embodiments of the application provide a computer-readable storage medium having a computer program stored on the computer-readable storage medium, the computer program, when executed by a processor, implements the steps and corresponding contents of the foregoing method embodiments.

Embodiments of the application also provide a computer program product including a computer program, the computer program when executed by a processor realizing the steps and corresponding contents of the preceding method embodiments.

The terms “first,” “second,” “third,” “fourth,” “1,” “2,” etc. in the specification and claims of this application and the accompanying drawings above are used to distinguish similar objects and need not be used to describe a particular order or sequence. It should be understood that the data so used is interchangeable where appropriate so that embodiments of the application described herein can be implemented in an order other than that illustrated or described in the text.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first integrated access backhaul (TAB) donor centralized unit (CU) in wireless communication system, the method comprising:
determining whether to perform an inter-donor handover (HO) of a mobile IAB mobile termination (MT) to a second IAB donor CU which is a target IAB donor CU; and
transmitting, to the second IAB donor CU, information on the inter-donor HO of the mobile IAB MT,
wherein the first IAB donor CU is a serving IAB donor CU for the mobile IAB MT.

2. The method of claim 1, further comprising:
identifying the second IAB donor CU which is a target IAB donor CU for a migration of a mobile IAB distributed unit (DU); and
transmitting, to the second IAB donor CU, information on the migration of the mobile IAB DU,
wherein the first IAB donor CU is a serving IAB donor CU For the mobile IAB DU.

3. The method of claim 2, wherein a radio resource control (RRC) connection is established between the mobile IAB MT and the second IAB donor CU, and
wherein an F1 connection is established between the mobile IAB DU and the third IAB donor CU.

4. The method of claim 2, wherein a third IAB donor CU is identified as the target IAB donor CU for the migration of the mobile IAB DU, and
wherein the third IAB donor CU is different from the second IAB donor CU.

5. The method of claim 2, wherein a third IAB donor CU is identified as the target IAB donor CU for the inter-donor HO and the migration of the mobile IAB DU, and
wherein the third IAB donor CU is different from the first IAB donor CU and the second IAB donor CU.

6. A method performed by a second integrated access backhaul (IAB) donor centralized unit (CU) in wireless communication system, the method comprising:
receiving, from a first IAB donor CU, information on an inter-donor handover (HO) of a mobile IAB mobile termination (MT),
wherein whether to perform the HO of the mobile IAB MT to the second IAB donor CU which is the target IAB donor CU is determined by the first IAB donor CU, and
wherein the first IAB donor CU is a serving IAB donor CU for the mobile IAB MT.

7. The method of claim 6, further comprising:
receiving, from the first IAB donor CU, information on a migration of a mobile IAB distributed unit (DU),
wherein the second IAB donor CU is identified as a target IAB donor CU for the migration of the mobile IAB DU, and
wherein the first IAB donor CU is a serving IAB donor CU For the mobile IAB DU.

8. The method of claim 7, wherein a radio resource control (RRC) connection is established between the mobile IAB MT and the second IAB donor CU, and
wherein an F1 connection is established between the mobile IAB DU and the third IAB donor CU.

9. The method of claim 7, wherein a third IAB donor CU is identified as the target IAB donor CU for the migration of the mobile IAB DU, and
wherein the third IAB donor CU is different from the second IAB donor CU.

10. The method of claim 7, wherein a third IAB donor CU is identified as the target IAB donor CU for the inter-donor HO and the migration of the mobile IAB DU, and
wherein the third IAB donor CU is different from the first IAB donor CU and the second IAB donor CU.

11. A first integrated access backhaul (IAB) donor centralized unit (CU) in a wireless communication system, the first IAB donor CU comprising:
a transceiver; and
at least one processor coupled with the transceiver and configured to:
determine whether to perform an inter-donor handover (HO) of a mobile IAB mobile termination (MT) to a second IAB donor CU which is a target IAB donor CU, and
transmit, to the second IAB donor CU, information on the inter-donor HO of the mobile IAB MT,
wherein the first IAB donor CU is a serving IAB donor CU for the mobile IAB MT.

12. The first IAB donor CU of claim 11, the at least one processor is configured to:
identify the second IAB donor CU which is a target IAB donor CU for a migration of a mobile IAB distributed unit (DU), and
transmit, to the second IAB donor CU, information on the migration of the mobile IAB DU,
wherein the first IAB donor CU is a serving IAB donor CU For the mobile IAB DU.

13. The first IAB donor CU of claim 12, wherein a radio resource control (RRC) connection is established between the mobile IAB MT and the second IAB donor CU, and
wherein an F1 connection is established between the mobile IAB DU and the third IAB donor CU.

14. The first IAB donor CU of claim 12, wherein a third IAB donor CU is identified as the target IAB donor CU for the migration of the mobile IAB DU, and
wherein the third IAB donor CU is different from the second IAB donor CU.

15. The first IAB donor CU of claim 12, wherein a third IAB donor CU is identified as the target IAB donor CU for the inter-donor HO and the migration of the mobile IAB DU, and
wherein the third IAB donor CU is different from the first IAB donor CU and the second IAB donor CU.

16. A second integrated access backhaul (IAB) donor centralized unit (CU) in wireless communication system, the second IAB donor CU comprising:
a transceiver; and
at least one processor coupled with the transceiver and configured to:
receive, from a first IAB donor CU, information on an inter-donor handover (HO) of a mobile IAB mobile termination (MT),
wherein whether to perform the HO of the mobile IAB MT to the second IAB donor CU which is the target IAB donor CU is determined by the first IAB donor CU, and
wherein the first IAB donor CU is a serving IAB donor CU for the mobile IAB MT.

17. The second IAB donor CU of claim 16, the at least one processor is configured to:
receive, from the first IAB donor CU, information on a migration of a mobile IAB distributed unit (DU),
wherein the second IAB donor CU is identified as a target IAB donor CU for the migration of the mobile IAB DU, and
wherein the first IAB donor CU is a serving IAB donor CU For the mobile IAB DU.

18. The second IAB donor CU of claim 17, wherein a radio resource control (RRC) connection is established between the mobile IAB MT and the second IAB donor CU, and
wherein an F1 connection is established between the mobile IAB DU and the third IAB donor CU.

19. The second IAB donor CU of claim 17, wherein a third IAB donor CU is identified as the target IAB donor CU for the migration of the mobile IAB DU, and
wherein the third IAB donor CU is different from the second IAB donor CU.

20. The second IAB donor CU of claim 17, wherein a third IAB donor CU is identified as the target IAB donor CU for the inter-donor HO and the migration of the mobile IAB DU, and wherein the third IAB donor CU is different from the first IAB donor CU and the second IAB donor CU.
